(19) United States
(12) Patent Application Publication
(10) Pub. No.: US 2026/0028923 A1
(43) Pub. Date: Jan. 29, 2026

(54) APPARATUS COMPRISING A PLURALITY OF TOOLS EACH HAVING AT LEAST ONE HYDRAULIC CHAMBER FOR HYDRAULIC LIQUID

(71) Applicant: FREEVALVE AB, Ängelholm (SE)

(72) Inventor: Anders HÖGLUND, Munka Ljungby (SE)

(21) Appl. No.: 18/993,035

(22) PCT Filed: Jul. 4, 2023
(86) PCT No.: PCT/SE2023/050695

§ 371 Date: Jan. 10, 2025

(30) Foreign Application Priority Data
Jul. 11, 2022 (SE) 2250884-0

(51) Int. Cl. F01L 9/10; B25D 9/12; F01L 1/30

(52) U.S. Cl. CPC F01L 9/10; F01L 1/30; B25D 9/125

(57) ABSTRACT

The invention relates to an apparatus (1) comprising a plurality of tools (2) each having at least one hydraulic chamber (6) for hydraulic liquid, and a hydraulic manifold (4) configured for storing pressurized hydraulic liquid and supplying hydraulic liquid to said plurality of tools (2), wherein each tool (2) comprises a communication conduit (7) extending between the hydraulic chamber (6) and said hydraulic manifold (4), the hydraulic chamber (6) having varying volume during the operation of the tool (2). The apparatus (1) is characterized in that each tool (2) comprises a hydraulic buffer unit (8) for preventing propagation of hydraulic pulsations between the tool (2) and the hydraulic manifold (4) in response to the varying volume of the hydraulic chamber (6), wherein the hydraulic buffer unit (8) has a buffer chamber (9) having varying volume in response to varying volume of the hydraulic chamber (6).

### TECHNICAL FIELD OF THE INVENTION

The present invention relates in general to an apparatus comprising a plurality of tools, wherein each tool comprises at least one hydraulic chamber having varying volume during operation of the tool.

The present invention relates in particular to an apparatus that comprises a plurality of tools each having at least one hydraulic chamber for hydraulic liquid, and comprises a hydraulic manifold configured for storing pressurized hydraulic liquid and supplying hydraulic liquid to said plurality of tools, wherein each tool comprises a communication conduit extending between the hydraulic chamber and said hydraulic manifold, the hydraulic chamber having varying volume during the operation of the tool.

Such apparatus is for instance constituted by a combustion engine assembly and machines having hydraulically driven devices/tools.

### BACKGROUND OF THE INVENTION

The present invention is based on the fact that many known applications/apparatus in various technical fields make use of a flow of hydraulic liquid that is utilized in connection with the operation of the apparatus, i.e. hydraulic liquid that flows between different locations in the apparatus in order to cause the apparatus to perform useful duty or in response to the apparatus performing useful duty.

Thus, many applications/apparatus in various technical fields make use of internal elements/components that are in motion during operation of the apparatus, wherein the pressurized hydraulic liquid is used for/in the operation of the apparatus. Such applications/apparatus having rapid displacements of the internal elements/components usually experience undesirable pulsations in the hydraulic liquid that counteract optimal operation. In some situations, such pulsations may also be harmful to the apparatus. Pulsations in the hydraulic liquid is especially undesired in apparatus having multiple hydraulically interconnected tools/devices.

In a camshaft free combustion engine, a pressure fluid is used to achieve a displacement/opening of one or more gas exchange valves. This means that the camshafts, and related equipment, that conventional combustion engines utilize to open the gas exchange valves to let air in respective let exhaust fumes out from the combustion chamber, has been replaced by a less volume demanding and more controllable system utilizing pneumatically/hydraulically operated actuators. During each cycle of the actuator, pressure fluid is supplied and discharged, and hydraulic liquid is supplied and returned. Such engines may operate at high numbers of revolutions/cycles, such as 6-8000 rpm, and may comprise eight or more pneumatically/hydraulically interconnected actuators, giving rise to an extreme situation of propagation of pulsation in the hydraulic liquid between the actuators.

There is a need in the art for a simple and reliable solution for apparatus having multiple tools, which in a reliable manner prevents propagation of pulsation in the hydraulic liquid between the tools.

### OBJECT OF THE INVENTION

The present invention aims at obviating the aforementioned disadvantages and failings of previously known apparatus, and at providing an improved apparatus. A primary object of the present invention is to provide an improved apparatus of the initially defined type wherein the operation of the individual tool does not have adverse effect on the operation of the other tools. It is another object of the present invention to provide an apparatus, which prevent adverse propagation of pulsation in the hydraulic liquid between the multiple tools without having adverse effect on the operation of the individual tool. It is another object of the present invention to provide an apparatus, which prevent adverse propagation of pulsation in the hydraulic liquid also when the hydraulic liquid pressure in the hydraulic manifold is altered.

### SUMMARY OF THE INVENTION

According to the invention at least the primary object is attained by means of the initially defined apparatus having the features defined in the independent claim. Preferred embodiments of the present invention are further defined in the dependent claims.

According to the present invention, there is provided an apparatus of the initially defined type, which is characterized in that each tool comprises a hydraulic buffer unit for preventing propagation of hydraulic pulsations between the tool and the hydraulic manifold in response to the varying volume of the hydraulic chamber, wherein the hydraulic buffer unit has a buffer chamber having varying volume in response to varying volume of the hydraulic chamber.

Thus, the present invention is based on the insight of having a local hydraulic buffer unit associated with each individual tool such that adverse propagation of pulsation in the hydraulic liquid in the hydraulic manifold due to operation of the individual tool is prevented. A central hydraulic buffer located in the hydraulic manifold and serving multiple tools will not prevent adverse propagation of pulsation in the hydraulic manifold.

According to various embodiments of the present invention, the hydraulic buffer unit comprises a cylinder accommodating a piston, the piston separating the buffer chamber and a pressure chamber from each other, wherein the piston is displaceable back and forth in the cylinder, wherein the pressure chamber accommodates a pressure fluid and a spring acting for displacing the piston towards the buffer chamber in order to decrease the volume of the buffer chamber, and wherein the buffer chamber is in fluid communication with the communication conduit, the pressurized hydraulic liquid acting for displacing the piston towards the pressure chamber in order to increase the volume of the buffer chamber.

According to various embodiments of the present invention, the piston is associated with a rest position located between two end positions within the cylinder, the pressure in the communication conduit being equal to the sum of the pressure of the pressure fluid in the pressure chamber of the cylinder and the spring force of the spring when the piston is located at said rest position. Thereby, when the piston has been displaced following the operation of the tool and the local pressure in the communication conduit is different than the general pressure in the hydraulic manifold, the piston will always strive to return to the rest position when the tool is not in operation thanks to a liquid communication with the hydraulic manifold that is slower than the change of volume of the hydraulic chamber of the tool during operation.

According to various embodiments of the present invention, the pressure in the hydraulic manifold is adjustable, the pressure level in the hydraulic manifold being adjusted based on the pressure level in the pressure chamber of the cylinder. Thus, the pressure level in the pressure chamber of the cylinder of the hydraulic buffer unit will change, i.e. increase or decrease, in response to a change of state of operation of the apparatus, and the pressure level in the hydraulic manifold will be changed accordingly in order to secure proper operation of the apparatus/tools.

According to various embodiments of the present invention, the apparatus is constituted by a combustion engine and each tool is constituted by an actuator configured for operating a gas exchange valve of the combustion engine.

According to various embodiments of the present invention, the combustion engine comprises a cylinder head and a cylinder head mantle together delimiting a cylinder head chamber, the actuator being arranged in the cylinder head chamber and the pressure chamber of the cylinder of the hydraulic buffer unit being in fluid communication with the cylinder head chamber.

According to various embodiments of the present invention, such actuator comprises an actuator piston arranged to displace said gas exchange valve, and wherein the actuator comprises at least one inlet opening for pressure fluid and at least one outlet opening for pressure fluid, the at least one outlet opening being in fluid communication with the cylinder head chamber and displacement of the actuator piston being executed by means of the pressure fluid.

Further advantages with and features of the invention will be apparent from the other dependent claims as well as from the following detailed description of preferred embodiments.

### BRIEF DESCRIPTION OF THE DRAWINGS

A more complete understanding of the abovementioned and other features and advantages of the present invention will be apparent from the following detailed description of preferred embodiments in conjunction with the appended drawings, wherein:

FIG. 1 is a schematic cross sectional side view of a part of an inventive apparatus,

FIG. 2 is a schematic cross-sectional side view of a part of a combustion engine,

FIG. 3-6 illustrate a schematic cross-sectional side view of an actuator/tool in different states of operation, and

FIG. 7 is a partly cross-sectional schematic perspective view of a cylinder head of a combustion engine.

### DETAILED DESCRIPTION OF PREFERRED EMBODIMENTS OF THE INVENTION

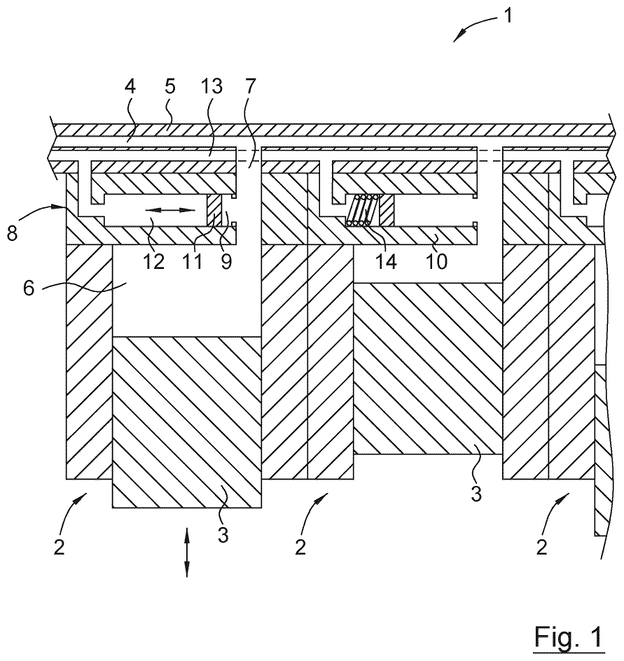

Reference is initially made to FIG. 1 that is a schematic depiction of a part of an inventive apparatus, generally designated 1. The apparatus 1 utilize hydraulic liquid in connection with the operation of the apparatus 1, i.e. hydraulic liquid flows between different locations in the apparatus in order to cause the apparatus 1 to perform useful duty or in response to the apparatus performing useful duty. The apparatus 1 comprises a plurality of tools, generally designated 2, having an element/component 3 that are in motion during the operation of the apparatus 1. The multiple tools 2 are hydraulically interconnected. The apparatus 1 comprises a hydraulic manifold 4 configured for storing pressurized hydraulic liquid and for suppling the hydraulic liquid to the plurality of tools 2.

The hydraulic manifold 4 may be constituted by a duct provided in a main body 5 of the apparatus 1, or by a separate conduit/component that is part of the apparatus 1.

According to various embodiments, the hydraulic manifold 4 of the apparatus 1 is also configured to receiving the hydraulic liquid from the plurality of tools 2. Thus, according to other embodiments the hydraulic liquid is supplied from the manifold 4 to the tool 2 and thereafter the hydraulic liquid is discharged to a suitable location inside or outside the apparatus 1, for instance to a sump or compressor (not disclosed) and then back to the manifold 4. A combination is also conceivable, i.e. a portion of the hydraulic liquid is discharged from the tool 2 and a portion is returned directly to the manifold 4.

Each tool 2 comprises at least one hydraulic chamber 6 for accommodating the hydraulic liquid, wherein the hydraulic chamber 6 has varying volume during the operation of the tool 2, i.e. in response to or in association with displacement/movement of the element 3. The displacement/movement of the element 3 may for instance be back and forth or rotational.

Each tool 2 comprises a communication conduit 7 extending between the hydraulic chamber 6 and the hydraulic manifold 4. Part of the communication conduit 7 may be located outside the tool 2, e.g. in the main body 5 of the apparatus 1.

It is essential that each tool 2 comprises a hydraulic buffer unit, generally designated 8. The buffer unit 8 is configured to prevent propagation of hydraulic pulsations between the tool 2 and the hydraulic manifold 4 in response to the varying volume of the hydraulic chamber 6. Thus, buffer unit 8 is configured such that the operation of an individual tool 2 shall not have adverse effect on the operation of another tool 2, concerning the supply of hydraulic liquid from the manifold 4.

The hydraulic buffer unit 8 comprises a buffer chamber 9 having varying volume in response to varying volume of the hydraulic chamber 6. Thus, when the volume of the hydraulic chamber 6 of the tool 2 increase the volume of the buffer chamber 9 decrease, i.e. at least part of the hydraulic liquid supplied to the hydraulic chamber 6 of the tool 2 in connection with operation of the tool 2 is supplied from the buffer chamber 9 of the buffer unit 8, in order to reduce the pulsation effect in the hydraulic manifold 4. According to various embodiment, when the volume of the hydraulic chamber 6 of the tool 2 decrease the volume of the buffer chamber 9 increase, i.e. at least part of the hydraulic liquid returned from the hydraulic chamber 6 of the tool 2 in connection with operation of the tool 2 is returned to the buffer chamber 9 of the buffer unit 8, in order to reduce the pulsation effect in the hydraulic manifold 4. The buffer chamber 9 of the buffer unit 8 may for instance comprise a flexible bellow/membrane, one or more displaceable walls, etc.

The buffer chamber 9 is in fluid communication with the communication conduit 7, the pressurized hydraulic liquid acting for increasing the volume of the buffer chamber 9.

According to various embodiments, such as disclosed in FIG. 1, the hydraulic buffer unit 8 comprises a cylinder 10 accommodating a piston 11, wherein the piston 11 is displaceable back and forth in the cylinder 10. The piston 11 separates the buffer chamber 9 and a pressure chamber 12 from each other in the cylinder 10. The pressure chamber 12 of each buffer unit 8 is preferably connected to a pressure fluid manifold 13 comprising a pressurized pressure fluid, such as gas/air. Thus, the pressure chamber 12 accommodates a pressure fluid acting for displacing the piston 11 towards the buffer chamber 9 in order to decrease the volume of the buffer chamber 9. The buffer chamber 9 is in fluid communication with the communication conduit 7, the pressurized hydraulic liquid acting for displacing the piston 11 towards the pressure chamber 12 in order to increase the volume of the buffer chamber 9.

The pressure level in the pressure fluid manifold 13 is preferably adjustable in order to suit the state of operation of the apparatus 1, i.e. the higher rpm/frequency of the apparatus 1 the higher pressure in the pressure fluid manifold 13. The pressure chamber 12 of each buffer unit 8 may alternatively be a closed cavity.

Preferably the pressure chamber 12 accommodates a spring 14, in addition to the pressure fluid, acting for displacing the piston 11 towards the buffer chamber 9 in order to decrease the volume of the buffer chamber 9.

The piston 11 is preferably displaced towards a rest position located between two end positions within the cylinder 10 in response to the volume of the hydraulic chamber 6 of the tool 2 momentarily does not alter during the operation of the tool 2. Thus, when the tool 2 does not receive or return hydraulic liquid to the hydraulic manifold 4, the buffer chamber 9 is still in fluid communication with the hydraulic manifold 4 and the piston 11 will be displaced towards the rest position, i.e. position of equilibrium in the cylinder 10, as long as there is a pressure difference between the pressure chamber 12 and the buffer chamber 9. Thus, the piston 11 is located at said rest position located between two end positions within the cylinder 10, when the pressure in the buffer chamber 9 of the cylinder 10 being equal to the pressure in the pressure chamber 12 of the cylinder 10.

According to various embodiments, the maximum change of volume of the hydraulic chamber 6 of the tool 2 is equal to or less than the idle-volume of the buffer chamber 9 of the cylinder 10 when the piston 11 is located at said rest position. Thus, under these circumstances no adverse pulsation of hydraulic liquid will propagate to the hydraulic manifold 4.

According to various embodiments, the maximum change of volume of the hydraulic chamber 6 of the tool 2 is equal to or less than the idle-volume of the pressure chamber 12 of the cylinder 10 when the piston 11 is located at said rest position. Thus, under these circumstances no adverse pulsation of hydraulic liquid will propagate to the hydraulic manifold 4.

According to the embodiments comprising a spring 14 in the pressure chamber 12, the piston 11 is located at said rest position when the pressure in the buffer chamber 9 is equal to the sum of the pressure of the pressure fluid in the pressure chamber 12 of the cylinder 10 and the spring force of the spring 14.

When the element 3 of the tool 2 is displaced during operation of the tool 2, i.e. when the volume of the hydraulic chamber 6 is altered, the volume of the buffer chamber 9 is altered rapidly in response to the changing volume of the hydraulic chamber 6. Thereafter, when the element 3 of the tool 2 is stationary, i.e. when the volume of the hydraulic chamber 6 is unchanging/fixed, the volume of the buffer chamber 9 is allowed to alter in order to return the piston 11 to the rest position.

According to various embodiments, the pressure in the hydraulic manifold 4 is adjustable, wherein the pressure level in the hydraulic manifold 4 is adjusted based on the prevailing pressure level in the pressure chamber 12 of the cylinder 10. Consequently, in some embodiments, based on the prevailing pressure level in the pressure fluid manifold 13.

The buffer unit 8 is associated with the individual tool 2, i.e. is part of or is located in direct connection with the tool 2. According to the disclosed embodiment, the hydraulic buffer unit 8 is located at the interface between the tool 2 and the main body 5 of the apparatus 1, i.e. at the top of the tool 2 or between the tool 2 and the main body 5 of the apparatus.

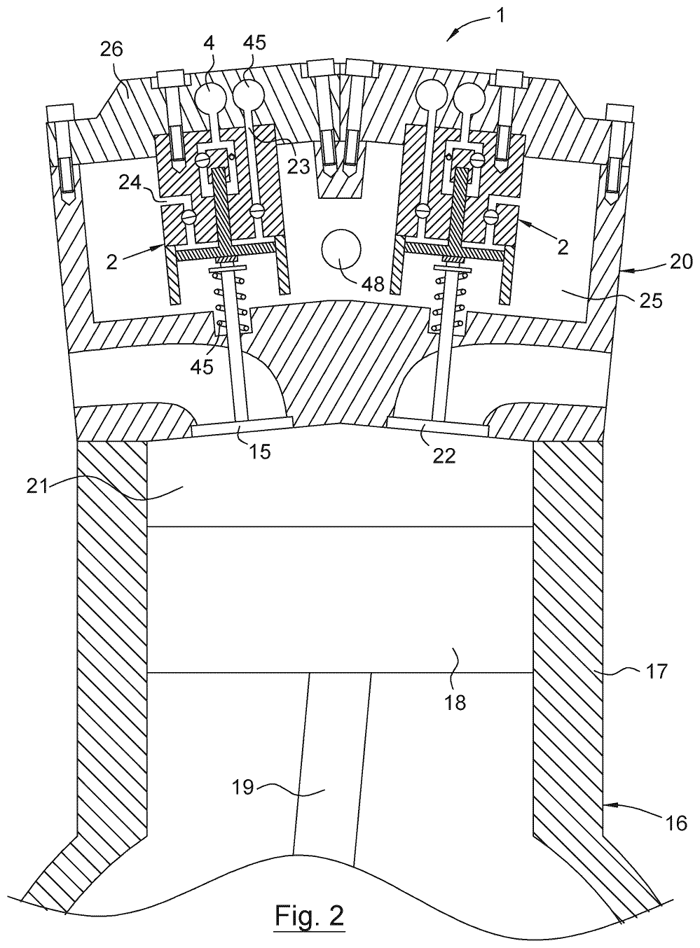

Reference is now made to FIGS. 2-7, wherein the apparatus 1 is constituted by a combustion engine and wherein the tool 2 is constituted by an actuator configured for operating a gas exchange valve 15 of the combustion engine. Thus, in the present document the term combustion engine shall be considered equivalent to apparatus and having the same reference number, and the term actuator shall be considered equivalent to tool and having the same reference number.

FIG. 2 disclose a schematic illustration of a part of an inventive combustion engine 1. The combustion engine 1 comprises a cylinder block 16 with at least one cylinder 17. Said cylinder block 16 may comprise one or a plurality of cylinders 17. In the disclosed embodiment one cylinder 17 is described, it should nevertheless be realized that he equipment described below in relation to the shown cylinder 17 is preferably applied to all of the cylinders of the combustion engine 1, in the embodiment the combustion engine comprises more cylinders.

Furthermore, the combustion engine 1 comprises a piston 18 that is axially displaceable in said cylinder 17. The movement, axial displacement forth and back, of the piston 18 is transferred on a conventional manner to a connection rod 19 connected to the piston 18, the connection rod 19 in turn is connected to and drives a crank shaft (not shown) in rotation.

The combustion engine 1 also comprises a cylinder head 20 that together with said cylinder 17 and said piston 18 delimits a combustion chamber 21. In the combustion chamber 21 the ignition of a mix of fuel and air occurs in a conventional manner and is not further described herein. The cylinder head 20 comprises a controllable first engine valve 15, also known as a gas exchange valve.

In the disclosed embodiment, the cylinder head also comprises a controllable second engine valve 22. Said first engine valve 15 constitutes, in the shown embodiment, an inlet valve that is arranged to selectively open/close for supply of air to the combustion chamber 21. The second engine valve 22 constitutes in the shown embodiment an air outlet valve, or exhaust valve, that is arranged to selectively open/close for evacuation of exhausts form the combustion chamber 21.

The combustion engine 1 further comprises a first valve actuator 2 that is operatively connected to said first engine valve 15 and that is arranged in a closed pressure fluid circuit of the combustion engine 1. The first valve actuator 2 comprises at least one inlet opening 23 for pressure fluid and at least one outlet opening 24 for pressure fluid. The pressure fluid may be a gas or a gas mixture, preferably air or nitrogen gas. The pressure fluid may alternatively be a hydraulic liquid. In the shown embodiment the combustion engine 1 also comprises a second valve actuator 2 that is operatively connected to said second engine valve 22 and that is arranged in said closed pressure fluid circuit parallel with said first valve actuator 2.

Each valve actuator 2 can be operatively connected with one or more gas exchange valves, for example the combustion engine may comprise two inlet valves which are jointly driven by the same valve actuator, however each valve actuator may drive one engine valve each to achieve the greatest possible control of the operation of the combustion engine 1.

The combustion engine 1 also comprises a cylinder head chamber 25 that forms part of said closed pressure fluid circuit and that is delimited by said cylinder head 20 and a cylinder head mantle 26. In the shown embodiment, the cylinder head mantle 26 is divided into two elements. The outlet opening 24 of the actuator 2 is in fluid communication with the cylinder head chamber, i.e. that the pressure fluid leaving the actuator 2 via said at least one outlet opening 24 flows out in the cylinder head chamber.

Preferably, the whole actuator 2 is arranged in said cylinder head chamber 25, and it is also preferred that the actuator 2 is direct or indirect releasably connected to the cylinder head mantle 26. In this embodiment, the actuator 2 accordingly “hangs” in the cylinder head mantle 26 without being in contact with the cylinder head 20. In an alternative example embodiment, the actuator 2 may be direct or indirect releasably connected to the cylinder head 20 in said cylinder head chamber 25.

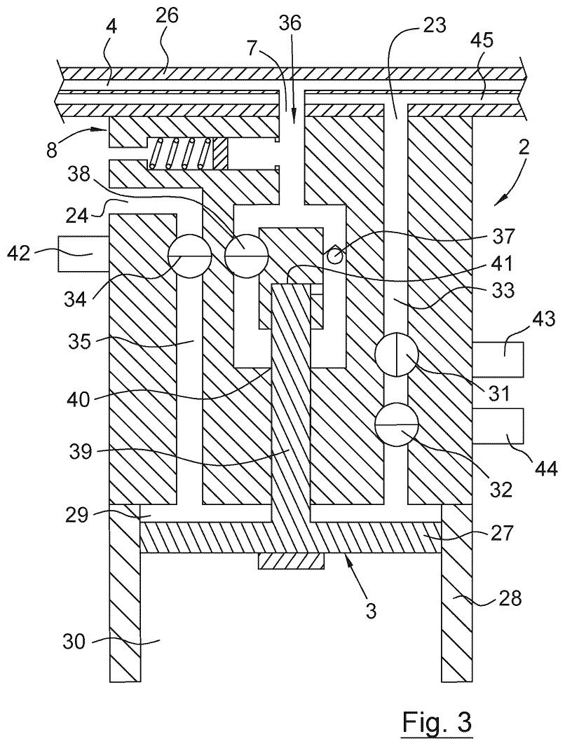

Reference is now primarily made to the FIGS. 3-6, which disclose the actuator 2 in different states of operation.

The actuator 2 comprises an actuator piston disc 27 and an actuator cylinder 28 delimiting a downward open cylinder volume, at least partly open. The actuator piston disc 27 divides said cylinder volume in a first upper part 29 and a second lower part 30 and is axially displaceable in said actuator cylinder 28. The actuator piston disc 27 constitute part of an actuator piston that is equivalent to the moving element 3 of the tool 2. The actuator piston 3 is arranged to contact and drive said engine valve 15.

The lower part 30 of the cylinder volume of the actuator 2 is in fluid communication with said cylinder head chamber 25. This way, it is guaranteed that the same pressure acts on the actuator piston disc 27 from the first/upper part 29 of the cylinder volume respective from the second/lower part 30 of the cylinder volume when the actuator piston 3 is in the upper turn position.

According to various embodiments, the actuator 2 comprises a controllable first inlet valve 31 and a controllable second inlet valve 32 arranged in an inlet channel 33 and arranged to open/close said inlet channel 33, a controllable outlet valve 34 arranged in an outlet channel 35 and arranged to open/close said outlet channel 35, a hydraulic circuit, generally designated 36, that in turn comprises a non-return valve 37 arranged to allow filling of the hydraulic circuit 36, and a controllable emptying valve 38 arranged to control the emptying of the hydraulic circuit 36. The inlet channel 33 is arranged between the pressure fluid inlet opening 23 and the first portion 29 of the cylinder volume of the cylinder 28. The outlet channel 35 is arranged between the pressure fluid outlet opening 24 and the first portion 29 of the cylinder volume of the cylinder 28.

The part of the hydraulic circuit 36 that is delimited by the non-return valve 37 and the controllable emptying valve 38 is equivalent to the hydraulic chamber 6 of the tool 2. The actuator 2 comprises a hydraulic buffer unit 8, configured as previously described. The pressure chamber 12 of the cylinder 10 of the buffer unit 8 is in fluid communication with the cylinder head chamber 25. Thus, the pressure fluid manifold 13 is in this context constituted by the cylinder head chamber 25.

The hydraulic manifold 4 is arranged in the cylinder head mantle 26. Thus, the main body 5 of the apparatus is in this context constituted by the cylinder head mantle 26. The communication conduit 7 is part of the hydraulic circuit 36.

The actuator piston 3 also comprises an actuator piston rod 39 wherein the actuator piston rod 39 is arranged to guide the actuator piston 3 during axial displacement. The actuator 2 comprises an actuator piston rod opening 40 receiving said actuator piston rod 39, wherein an upper end 41 of the actuator piston rod 39 is arranged to be displaced in the axial direction relative to said hydraulic circuit 36 in connection with axial displacement of the actuator piston disc 27 in the cylinder volume.

It should be pointed out that the controllable valves in the valve actuator 2 are schematically depicted and can for example be constituted by sliding valves, seat valves, etc. Furthermore, several of the abovementioned controllable valves may be constituted by a single body. Each valve can further be directly or indirectly electrically controlled. With directly electrically controlled is meant that the position of the valve is directly controlled by, for example, an electro-magnetic device, and with indirect electrically controlled is meant that the position of the valve is controlled by a pressure fluid that in turn is controlled by, for example, an electro-magnetic device.

In FIG. 3, the actuator 2 is in an inactive state and ready for being set in an active state. The second controllable inlet valve 32, the outlet valve 34, and the emptying valve 38 of the hydraulic circuit 36 are closed. The first controllable inlet valve 31 is open. The actuator piston disc 27 is accordingly in an upper position, and the actuator piston 3 is ready to open the engine valve (not shown in FIGS. 2-6, see FIG. 1). The controllable emptying valve 38 and the controllable outlet valve 34 may be controlled simultaneously. The controllable emptying valve 38 and the controllable outlet valve 34 may be operated by one single electromagnetic solenoid 42. The controllable first inlet valve 31, the controllable second inlet valve 32, the controllable outlet valve 34 and the controllable emptying valve 38 may be controlled by a control unit. In FIG. 3 the controllable first inlet valve 31 is inactivated in its open position whereas the second controllable inlet valve 32, the controllable outlet valve 34 and the controllable emptying valve 38 are inactivated in the closed positions. This setup may help in saving consumed energy for the actuator 2 when in operation.

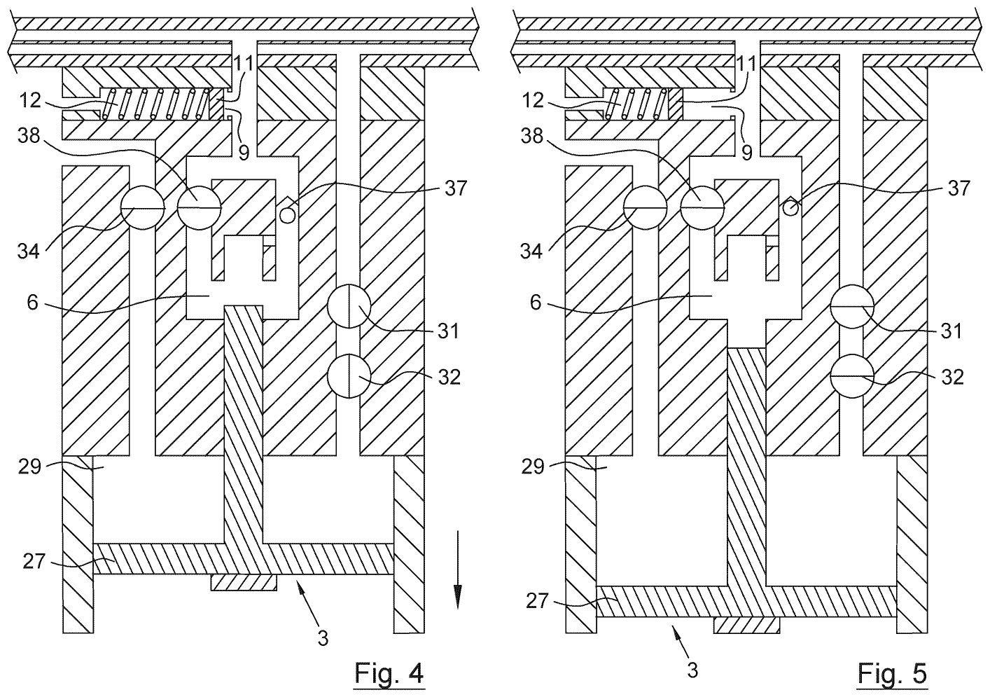

In FIG. 4, the second controllable inlet valve 32 has been opened to allow filling of pressure fluid with a high pressure to the upper part 29 of the cylinder volume, after which the actuator piston disc 27 starts a downward movement, i.e. is displaced downward, denoted by arrow in FIG. 4. The non-return valve 37 of the hydraulic circuit 36 allows for the hydraulic fluid to be sucked into the hydraulic chamber 6 and replace the volume that the actuator piston 3 leaves. Pressure fluid can only fill the upper part 29 of the cylinder volume when said first controllable inlet valve 31 and the second controllable inlet valve 32 are open simultaneously, i.e. overlapping. Said first controllable inlet valve 31 and said second controllable inlet valve 32 may be in said open position simultaneously during a so-called overlapping time period. The overlapping time period is shorter compared to an opening time of said controllable first inlet valve 31 and compared to an opening time of said controllable second inlet valve 32. It should be noted that said first controllable inlet valve 31 and said second controllable inlet valve 32 during said overlapping time period need not be fully open, i.e. the first controllable inlet valve 31 and/or said second controllable inlet valve 32 may be partially open during said overlapping time period. By partly open means that the specific valve is in motion from fully closed to fully open, or from fully open to fully closed. A final active position of said piston disc 3 is defined by the overlapping time period and the pressure of the pressure fluid. The first controllable inlet valve 31 is operated by an electromagnetic solenoid 43. The second controllable inlet valve 32 is operated by an electromagnetic solenoid 44. The overlapping time period is typically less than 3 ms. In various example embodiment said overlapping time period is in the range 1-2 ms.

When the actuator piston 3 is displaced downwards and the volume of the hydraulic chamber 6 is increased, the piston 11 of the buffer unit 8 is displaced towards the buffer chamber 9.

In FIG. 5, the first controllable inlet valve 31 has been closed in order to stop supply of pressure fluid to the upper part 29 of the cylinder volume. Thereafter, the second controllable inlet valve 32 has also been closed in order to return to its default/initial position. The pressure fluid in the upper part 29 of the cylinder volume is not capable of displacing the actuator piston disc 27 further. The actuator piston disc 27 is kept in place (is locked) in its lower position a desired amount of time by the emptying valve 38 of the hydraulic circuit 36 being kept closed at the same time as the non-return valve 37 of the hydraulic circuit 36 is closed automatically.

When the actuator piston 3 is stationary the piston 11 of the buffer unit 8 is displaced towards the pressure chamber 12 and towards the rest position.

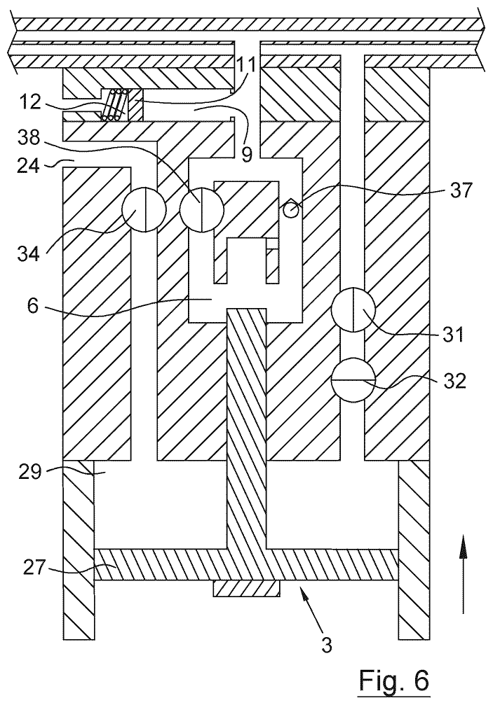

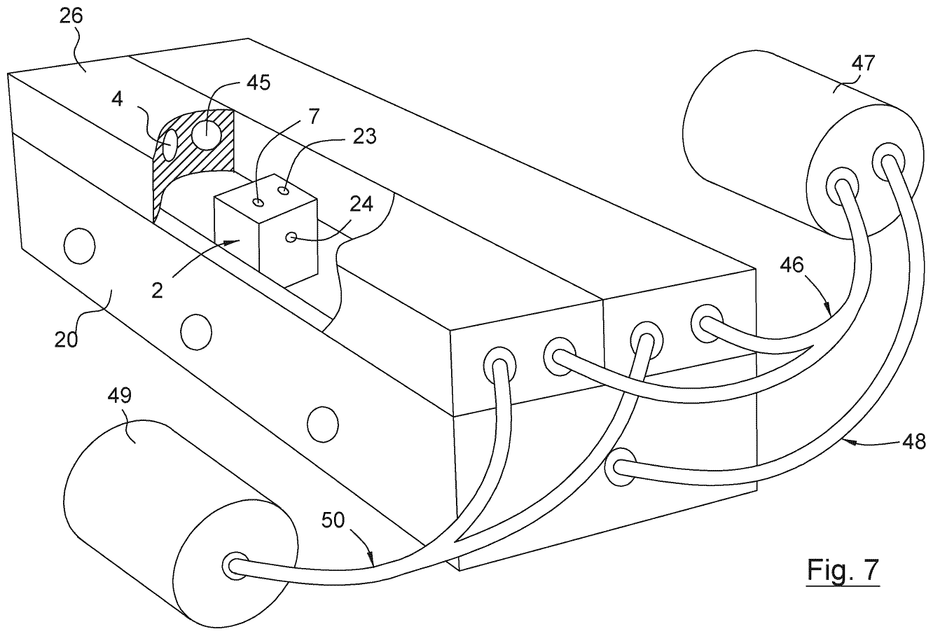

According to the disclosed embodiment the second inlet valve 32 is set in the fully closed position before the first inlet valve 31 is opened, i.e. FIG. 5, and thereafter the first inlet valve 31 is opened, i.e. FIG. 6.

In FIG. 6, the outlet valve 34 has been opened to admit an evacuation of pressure fluid from the upper part 29 of the cylinder volume, and additionally the emptying valve 38 of the hydraulic circuit 36 has been opened, after which the actuator piston disc 27 is displaced upwards, denoted by arrow in FIG. 6. Thus, the hydraulic fluid is evacuated from the hydraulic chamber 6 of the hydraulic circuit 36, and at the same time pressure fluid is evacuated from the upper part 29 of the cylinder volume to the cylinder head chamber 25.

When the actuator piston 3 is displaced upwards and the volume of the hydraulic chamber 6 is decreased, the piston 11 of the buffer unit 8 is displaced towards the pressure chamber 12.

The hydraulic liquid is preferably oil, and most preferably of the same type as the normal engine oil of the combustion engine 1.

Reference is now made to FIG. 7, which schematically shows the cylinder head 20 and the cylinder head mantle 26.

The cylinder head mantle 26 comprises a pressure fluid manifold 45 that is connected to the at least one inlet opening 23 of the actuator 2. The pressure fluid manifold 45 extends along the axial length of the cylinder head mantle 26. Said pressure fluid manifold 45 forms part of a primary pressure fluid channel 46 that extends from a compressor 47 to the at least one inlet opening 23 of the actuator 2. The compressor 47 is arranged to supply a pressure fluid under high pressure to the valve actuators. Furthermore, a secondary pressure fluid channel 48 (see also FIG. 1) extends from the cylinder head chamber 25 to said compressor 47.

The compressor 47 has variable compressor volume/displacement, or by other means adjustable output, and generally the compressor 47 is driven by the crank shaft of the combustion engine 1. At high numbers of revolutions and high torque output, higher pressure of the pressure fluid in the primary pressure fluid channel 46 is required, and at low numbers of revolutions and low torque output, lower pressure of the pressure fluid in the primary pressure fluid channel 46 is required.

The cylinder head mantle 26 further comprises the hydraulic liquid manifold 4 that is connected to the communication conduit 7 of said hydraulic circuit 36 of the valve actuator 2. The hydraulic liquid manifold 4 extends along the axial length of the cylinder head 26, parallel to the pressure fluid manifold 45. A pump 49, or the like, is arranged to supply a pressurized hydraulic liquid to the hydraulic liquid manifold 4 via a conduit 50.

The cylinder head mantle 26 may further comprise all necessary electric infrastructure (not shown) for, among other things, controlling the valve actuators 2, for various sensors, etc.

### Feasible Modifications of the Invention

The invention is not limited only to the embodiments described above and shown in the drawings, which primarily have an illustrative and exemplifying purpose. This patent application is intended to cover all adjustments and variants of the preferred embodiments described herein, and the present invention is consequently defined by the wording of the appended claims and the equivalents thereof and the equipment can be modified in all conceivable ways within the scope of the appended claims.

It shall also be pointed out that all information about/concerning terms such as above, under, upper, lower, etc., shall be interpreted/read having the equipment oriented according to the figures, having the drawings oriented such that the references can be properly read. Thus, such terms only indicates mutual relations in the shown embodiments, which relations may be changed if the inventive equipment is provided with another structure/design.

It shall also be pointed out that even thus it is not explicitly stated that features from a specific embodiment may be combined with features from another embodiment, the combination shall be considered/regarded obvious, when the combination is possible.

1. Apparatus (1) comprising:
a plurality of tools (2) each having at least one hydraulic chamber (6) for hydraulic liquid,
a hydraulic manifold (4) configured for storing pressurized hydraulic liquid and supplying hydraulic liquid to said plurality of tools (2),
wherein each tool (2) comprises a communication conduit (7) extending between the hydraulic chamber (6) and said hydraulic manifold (4), the hydraulic chamber (6) having varying volume during the operation of the tool (2),
characterized in that each tool (2) comprises a hydraulic buffer unit (8) for preventing propagation of hydraulic pulsations between the tool (2) and the hydraulic manifold (4) in response to the varying volume of the hydraulic chamber (6), wherein the hydraulic buffer unit (8) has a buffer chamber (9) having varying volume in response to varying volume of the hydraulic chamber (6).

2. The apparatus (1) according to claim 1, wherein the hydraulic buffer unit (8) comprises a cylinder (10) accommodating a piston (11), the piston (11) separating the buffer chamber (9) and a pressure chamber (12) from each other, wherein the piston (11) is displaceable back and forth in the cylinder (10),
wherein the pressure chamber (12) accommodates a pressure fluid acting for displacing the piston (11) towards the buffer chamber (9) in order to decrease the volume of the buffer chamber (9), and
wherein the buffer chamber (9) is in fluid communication with the communication conduit (7), the pressurized hydraulic liquid acting for displacing the piston (11) towards the pressure chamber (12) in order to increase the volume of the buffer chamber (9).

3. The apparatus (1) according to claim 2, wherein the pressure chamber (9) accommodates the pressure fluid and a spring (14) acting for displacing the piston (11) towards the buffer chamber (9) in order to decrease the volume of the buffer chamber (9).

4. The apparatus (1) according to claim 2, wherein the piston (11) is displaced towards a rest position located between two end positions within the cylinder (10) in response to the volume of the hydraulic chamber (6) momentarily does not alter during the operation of the tool (2).

5. The apparatus (1) according to claim 2, wherein the piston (11) is associated with a rest position located between two end positions within the cylinder (10), the pressure in the buffer chamber (9) of the cylinder (10) being equal to the pressure in the pressure chamber (12) of the cylinder (10) when the piston (11) is located at said rest position.

6. The apparatus (1) according to claim 2, wherein the pressure in the hydraulic manifold (4) is adjustable, the pressure level in the hydraulic manifold (4) being adjusted based on the pressure level in the pressure chamber (12) of the cylinder (10) of the buffer unit (8).

7. The apparatus (1) according to claim 2, wherein the piston (11) is associated with a rest position located between two end positions within the cylinder (10), and wherein the maximum change of volume of the hydraulic chamber (6) of the tool (2) is equal to or less than the idle-volume of the buffer chamber (9) of the cylinder (10) when the piston (11) is located at said rest position.

8. The apparatus (1) according to claim 2, wherein the piston (11) is associated with a rest position located between two end positions within the cylinder (10), and wherein the maximum change of volume of the hydraulic chamber (6) of the tool (2) is equal to or less than the idle-volume of the pressure chamber (12) of the cylinder (10) when the piston (11) is located at said rest position.

9. The apparatus (1) according to claim 1, wherein the hydraulic buffer unit (8) of each tool (2) is located at the interface between the tool (2) and a main body (5) of the apparatus (1) comprising the hydraulic manifold (4).

10. The apparatus (1) according to claim 1, wherein the apparatus (1) is constituted by a combustion engine and wherein the tool (2) is constituted by an actuator configured for operating a gas exchange valve (15) of the combustion engine.

11. The apparatus according to claim 10, wherein the combustion engine (1) comprises a cylinder head (20) and a cylinder head mantle (26) together delimiting a cylinder head chamber (25), the actuator (2) being arranged in the cylinder head chamber (25) and the pressure chamber (12) of the cylinder (10) of the hydraulic buffer unit (8) being in fluid communication with the cylinder head chamber (25).

12. The apparatus (1) according to claim 11, wherein the hydraulic manifold (4) is arranged in the cylinder head mantle (26).

13. The apparatus (1) according to claim 11, wherein the actuator (2) comprises an actuator piston (3) arranged to displace said gas exchange valve (15), and wherein the actuator (2) comprises at least one inlet opening (23) for pressure fluid and at least one outlet opening (24) for pressure fluid, the at least one outlet opening (24) being in fluid communication with the cylinder head chamber (25) and displacement of the actuator piston (3) being executed by means of the pressure fluid.

14. The apparatus (1) according to claim 13, wherein the cylinder head mantle (26) comprises a pressure fluid manifold (45) that is connected to the at least one inlet opening (23) of the actuator (2).
